(19) United States
(12) Patent Application Publication
(10) Pub. No.: US 2026/0268865 A1
(43) Pub. Date: Sep. 10, 2026

(54) METHOD FOR CONTROLLING DIRECTION OF DATA STREAM, AND DIMMER AND BACKLIGHT UNIT

(71) Applicant: BEIJING XIANXIN TECHNOLOGY CO., LTD, Beijing (CN)

(72) Inventors: Kiwon LEE, Beijing (CN); Youngjin LIM, Beijing (CN); Chenghui YAN, Beijing (CN)

(21) Appl. No.: 19/165,129

(22) PCT Filed: Mar. 13, 2024
(86) PCT No.: PCT/CN2024/081478

§ 371 Date: Sep. 14, 2025

(30) Foreign Application Priority Data
Mar. 15, 2023 (CN) 202310250806.5

(51) Int. Cl. G09G 3/34

(52) U.S. Cl. CPC G09G 3/3426; G09G 2320/0626

(57) ABSTRACT

A method for controlling the direction of a data stream, and a dimmer and a backlight unit (13). The method comprises: a dimmer first receives an input signal by means of input and output pins, and detects the level state of the input signal (401); the dimmer then selects one input and output pin from two input and output pins of the dimmer as an input pin according to the detected level state and on the basis of a first preset duration (402); and finally, the dimmer uses the other input and output pin except the input pin as an output pin, so that dimming data is transmitted from the input pin to the output pin (403). According to the detected level state and the first preset duration, the dimmer sets one input and output pin as the input pin, and sets the other input and output pin as the output pin, such that the direction of a data stream in the dimmer is determined; and because the direction of the data stream in the dimmer can be flexibly set, the wiring mode of the dimmer in the backlight unit (13) is simplified, and the space efficiency of the backlight unit (13) is improved.

### CROSS-REFERENCE TO RELATED APPLICATIONS

The present application is a National Stage of International Application No. PCT/CN2024/081478, filed on Mar. 13, 2024, which claims priority to Chinese patent application No. 202310250806.5, filed with China National Intellectual Property Administration on Mar. 15, 2023, the entire contents of which are incorporated by reference into the present application.

### TECHNICAL FIELD

The present application relates to the field of display technology, and in particular to a method for controlling a direction of data stream, a dimmer and a backlight unit.

### BACKGROUND

With the development of local dimming technology, the performance of liquid crystal display (LCD) has been greatly improved. The local dimming system includes the timing controller (TCON), the dimmer controller (DCON) and the backlight unit (BLU). The backlight unit is an important part of the local dimming system. The performance of the backlight unit will directly affect the display effect of the image. Specifically, the performance of the backlight unit can be reflected in its spatial efficiency.

The backlight unit includes dimmers and mini light emitting diodes (Mini LED). The configuration and wiring of the dimmer will affect the spatial efficiency of the backlight unit. Since the main direction of the data stream in the backlight unit is usually determined as one direction, in the related art, in the backlight unit with high spatial efficiency, the wiring of the dimmer is very complicated.

### SUMMARY

The present application provides a method for controlling a direction of data stream, a dimmer and a backlight unit, so as to solve the problem that the backlight unit in the prior art cannot have both high space efficiency and simple wiring of the dimmer.

In a first aspect, an embodiment of the present application provides a method for controlling a direction of data stream, performed by a backlight unit, where the backlight unit includes a dimmer, and the method includes: receiving, by the dimmer, input signals through input/output pins, and detecting by the dimmer, level states of the input signals; selecting, by the dimmer, an input/output pin from two input/output pins of the dimmer as an input pin based on the detected level states and based on a first preset time length; and using, by the dimmer, another input/output pin other than the input pin as an output pin, to cause that dimming data is transmitted from the input pin to the output pin.

In the method for controlling the direction of data stream provided by the embodiment of the present application, the dimmer first receives input signals through input/output pins and detects the level states of the input signals; then, based on the detected level state and the first preset time length, selects an input/output pin from the two input/output pins of the dimmer as an input pin; and finally, uses another input/output pin other than the input pin as an output pin, so that the dimming data is transmitted from the input pin to the output pin. The dimmer sets one input/output pin as an input pin and another input/output pin as an output pin based on the detected level state and the first preset time length, so that the dimming data is transmitted from the input pin to the output pin, thereby determining the direction of data stream in the dimmer. Since the direction of data stream in the dimmer can be flexibly set, the wiring of the backlight unit can be simplified, and the space efficiency of the backlight unit can be improved.

In an optional implementation, the selecting, by the dimmer, an input/output pin from two input/output pins of the dimmer as an input pin based on the detected level states and based on a first preset time length, includes: using, by the dimmer, the input/output pin the detected level state of which is a preset level state and the preset level state of which lasts for the first preset time length as the input pin.

In the above method, the dimmer continuously detects the level state of the input signal, and if the level state is detected to be the preset level state within the first preset time length, the dimmer sets the input/output pin as the input pin for inputting dimming data. Since the dimmer needs to continuously detect the preset level state within the first preset time length, the probability of level jumps due to interference in the connection line can be reduced, thereby reducing the probability of the input/output pins being incorrectly set, and improving the stability and accuracy of the system.

In an optional implementation, in response to that the level states detected by the dimmer are the preset level state, and the input/output pins for which the preset level state lasts for the first preset time length include the two input/output pins, the method further includes: determining, by the dimmer, an input/output pin that receives an input signal in the preset level state earlier from the two input/output pins; and using, by the dimmer, the determined input/output pin as the input pin.

In the above method, if the level states detected by the dimmer are the preset level state, and the input/output pins for which the preset level state lasts for the first preset time length include two input/output pins, then the input/output pin that receives the input signal in the preset level state earlier from the two input/output pins is determined and used as the input pin, and another input/output pin other than the input pin is set as the output pin, thereby ensuring the accuracy and uniqueness of the direction of data stream in the dimmer.

In an optional implementation, in response to that the backlight unit includes at least one group of cascaded dimmers, for each dimmer in each group of cascaded dimmers, the method further includes: receiving, by the dimmer, an input signal in a preset level state through the input pin within a second preset time length, and outputting, by the dimmer, a signal in the preset level state to a next-level dimmer connected to the dimmer through the output pin within a third preset time length; where the third preset time length is a product of the first preset time length and a quantity of subsequent-level dimmers of the dimmer, and the second preset time length is a sum of the third preset time length and the first preset time length.

In the above method, the backlight unit includes at least one group of cascaded dimmers. For each dimmer in each group of cascaded dimmers, the dimmer receives the input signal in the preset level state through the input pin within the second preset time length, and outputs the signal in the preset level state to the next-level dimmer connected to the dimmer through the output pin within the third preset time length. Through this method, the step-by-step determination of the direction of data stream in the dimmer is achieved, that is, after the direction of data stream of the first-level dimmer is determined, the direction of data stream of the second-level dimmer is determined, and so on, to ensure that the direction of data stream of each dimmer in the backlight unit is determined.

In an optional implementation, the method further includes: in response to that a preset condition is met, determining, by the dimmer, the two input/output pins of the dimmer as input pins; where the preset condition is any one of following conditions: condition 1: the dimmer is reset; condition 2: the backlight unit is powered on; or condition 3: the backlight unit is powered off.

In the above method, if the backlight unit is powered on, or the backlight unit is powered off, or the dimmer is reset, the two input/output pins of the dimmer are restored to the initial state, that is, the two input/output pins are set to input pins. However, if none of the above situations occurs, the input/output pins of the dimmer remain unchanged to prevent the dimmer from being switched to an unexpected direction of data stream during the operation of the backlight unit, thereby damaging the dimming system or even burning the dimmer.

In a second aspect, an embodiment of the present application provides a dimmer, included in a backlight unit, where the dimmer includes: a signal processing module, configured for receiving input signals through input/output pins and detecting level states of the input signals; a first determining module, configured for selecting an input/output pin from two input/output pins of the dimmer as an input pin based on the detected level states and based on a first preset time length; and a second determining module, configured for using another input/output pin other than the input pin as an output pin, to cause that dimming data is transmitted from the input pin to the output pin.

In an optional implementation, the first determining module is configured for: using the input/output pin the detected level state of which is a preset level state and the preset level state of which lasts for the first preset time length as the input pin.

In an optional implementation, the first determining module is further configured for: determining the input/output pin that receives an input signal in the preset level state earlier from the two input/output pins; and using the determined input/output pin as the input pin.

In an optional implementation, in response to that the backlight unit includes at least one group of cascaded dimmers, for each dimmer in each group of cascaded dimmers, the dimmer further includes an input-output module, configured for: receiving an input signal in a preset level state through the input pin within a second preset time length, and outputting a signal in the preset level state to a next-level dimmer connected to the dimmer through the output pin within a third preset time length; where the third preset time length is a product of the first preset time length and a quantity of subsequent-level dimmers of the dimmer, and the second preset time length is a sum of the third preset time length and the first preset time length.

In an optional implementation, the dimmer further includes a reset module, configured for: in response to that a preset condition is met, setting the two input/output pins of the dimmer as input pins; where the preset condition is any one of following conditions: condition 1: the dimmer is reset; condition 2: the backlight unit is powered on; or condition 3: the backlight unit is powered off.

In a third aspect, an embodiment of the present application provides a dimmer included in a backlight unit, where the dimmer includes a memory and a processor, where the memory stores a computer program, and when the processor executes the computer program to implement the method for controlling the direction of data stream as described in any one of the embodiments of the first aspect above are implemented.

In a fourth aspect, an embodiment of the present application provides a backlight unit, including a Mini LED and a dimmer as described in the third aspect above, where: the dimmer is configured for adjusting brightness of the Mini LED connected to the dimmer based on the dimming data.

In a fifth aspect, an embodiment of the present application provides a computer-readable storage medium, which stores computer instructions. When the computer instructions are executed on a computer, the computer executes the method for controlling the direction of data stream as described in any embodiment of the first aspect.

For the technical effects that may be achieved by the dimmer disclosed in the second aspect, the dimmer disclosed in the third aspect, the backlight unit disclosed in the fourth aspect, and the computer-readable storage medium disclosed in the fifth aspect, please refer to the technical effects that can be achieved by the first aspect or various possible schemes in the first aspect, and no further details will be given here.

### BRIEF DESCRIPTION OF FIGURES

In order to more clearly illustrate the technical solutions in the embodiments of the present application, the drawings required for use in the description of the embodiments will be briefly introduced below. Obviously, the drawings described below are only some embodiments of the present application. For ordinary technicians in this field, other drawings can be obtained based on these drawings without paying any creative labor.

FIG. 1 is a schematic diagram of an application scenario of a method for controlling a direction of data stream provided by an embodiment of the present application.

FIG. 2 is a schematic structural diagram of a backlight unit provided in the related art.

FIG. 3 is another schematic structural diagram of a backlight unit provided in the related art.

FIG. 4 is a flow chart of a method for controlling a direction of data stream provided in an embodiment of the present application.

FIG. 5 is a circuit structure diagram of a dimmer provided in an embodiment of the present application.

FIG. 6A is a waveform diagram of input signals received by a dimmer provided in an embodiment of the present application.

FIG. 6B is another waveform diagram of input signals received by a dimmer provided in an embodiment of the present application.

FIG. 7 is a circuit structure diagram of a connection of a DCON with dimmers provided in an embodiment of the present application.

FIG. 8 is another waveform diagram of input signals received by dimmers provided in an embodiment of the present application.

FIG. 9A is another circuit structure diagram of a connection of a DCON with dimmers provided in an embodiment of the present application.

FIG. 9B is another circuit structure diagram of a connection of a DCON with dimmers provided in an embodiment of the present application.

FIG. 9C is another circuit structure diagram of a connection of a DCON with dimmers provided in an embodiment of the present application.

FIG. 9D is another circuit structure diagram of a connection of a DCON with dimmers provided in an embodiment of the present application.

FIG. 10 is a schematic diagram of a module structure of a dimmer provided in an embodiment of the present application.

FIG. 11 is a schematic structural diagram of a dimmer provided in an embodiment of the present application.

FIG. 12 is a schematic diagram of a program product of a method for controlling a direction of data stream provided in an embodiment of the present application.

### DETAILED DESCRIPTION

In order to make the purpose, technical solutions and advantages of the present application clearer, the present application will be further described in detail below in conjunction with the accompanying drawings. Obviously, the described embodiments are only part of the embodiments of the present application, rather than all the embodiments. Based on the embodiments in the present application, all other embodiments obtained by ordinary technicians in this field without creative work are within the scope of protection of the present application.

It should be noted that the terms “first”, “second”, etc., in the specification and claims of the present application and the above-mentioned drawings are used to distinguish similar objects, and are not necessarily used to describe a specific order or sequence. It should be understood that the data used in this way can be interchangeable where appropriate, so that the embodiments of the present application described herein can be implemented in an order other than those illustrated or described herein. The embodiments described in the following exemplary embodiments do not represent all embodiments consistent with the present application. On the contrary, they are merely examples of devices and methods consistent with some aspects of the present application as detailed in the attached claims.

The purpose, features and advantages of the present application will be further described in conjunction with the embodiments and with reference to the accompanying drawings. It should be understood that the specific embodiments described herein are only used to explain the present application and are not intended to limit the present application.

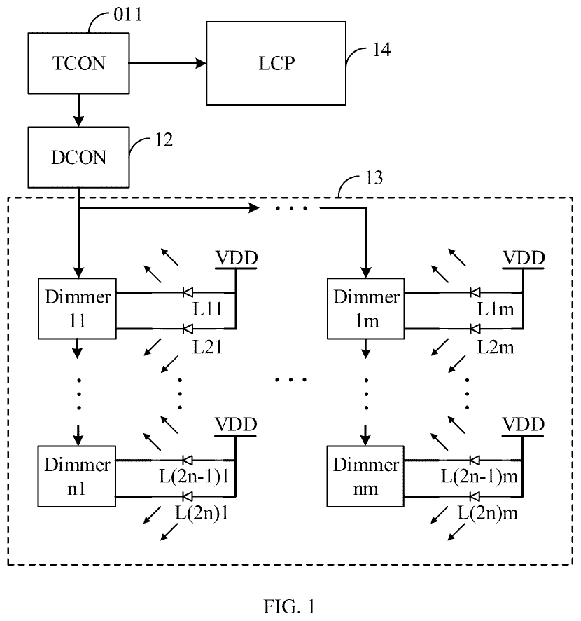

As shown in FIG. 1, an application scenario of a method for controlling a direction of data stream provided in an embodiment of the present application, the local dimming system includes a timing controller (TCON) 011, a dimmer controller (DCON) 12 and a backlight unit (BLU) 13. The backlight unit 13 includes a backlight matrix composed of a plurality of Mini LEDs (L11, . . . , L(2n)m) and a plurality of dimmers (Dimmer 11, . . . , Dimmer nm). Exemplary, the Mini LEDs (L11, . . . , L(2n)m) can be direct-type AM (Active Matrix) Mini LEDs. The quantity of Mini LEDs constituting the backlight matrix can be determined according to the size of the liquid crystal panel (LCP) 14, and the quantity of dimmers can be determined according to the quantity of Mini LEDs, and for example, one dimmer can control two Mini LEDs, and one dimmer can also control four Mini LEDs. The embodiment of the present application is described by taking one dimmer controlling two Mini LEDs as an example.

In a specific implementation, the timing controller 011 is connected to the dimmer controller 12 and the liquid crystal panel 14, and is used to transmit the local dimming data to the dimmer controller 12, and transmit the display image signal to the liquid crystal panel 14, so that the liquid crystal panel 14 displays the image according to the display image signal. The dimmer controller 12 is also connected to the dimmer (Dimmer 11, . . . , Dimmer nm) in the backlight unit 13, and is used to control the dimmer (Dimmer 11, . . . , Dimmer nm). Specifically, the interface connecting the dimmer controller 12 and the dimmer (Dimmer 11, . . . , Dimmer nm) can be a single line interface with a clock embedded to achieve simple and effective wiring, or can be a dual line interface with a clock and data separated to achieve stable and accurate communication. The dimmers (Dimmer 11, . . . , Dimmer nm) can also be distributed in a matrix according to the distribution of the backlight matrix. Taking the first-level dimmer (Dimmer 11) as an example, since it controls two Mini LEDs (L11, L21), the first output terminal of Dimmer 11 is electrically connected to the cathode of the Mini LED L11, the second output terminal of Dimmer 11 is electrically connected to the cathode of the Mini LED L21, the anode of Mini LED L11 and the anode of Mini LED L21 are both connected to the power supply terminal VDD, and the connection method of other level dimmers is similar to that of the Dimmer 11, and the repeated parts are not repeated. The dimmer (Dimmer 11, . . . , Dimmer nm) is used to control the brightness of the Mini LED connected thereto according to the received local dimming data, thereby adjusting the brightness of the backlight unit 13.

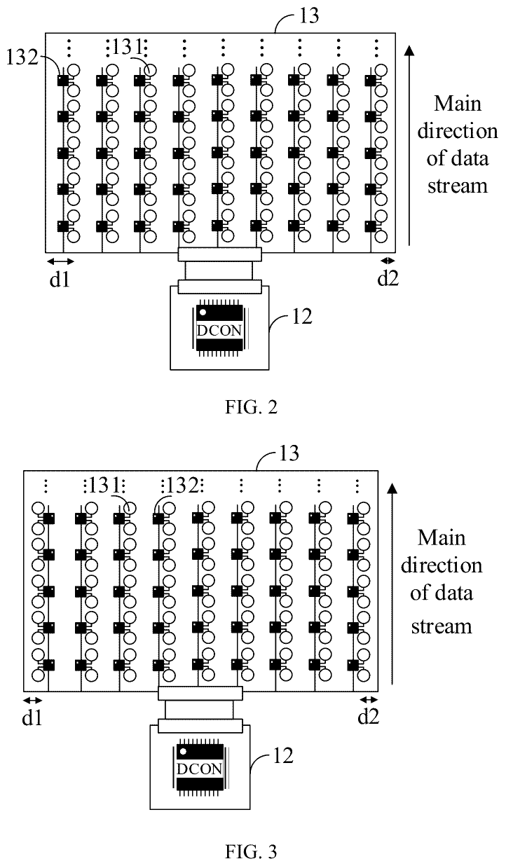

FIG. 2 is a schematic structural diagram of a backlight unit provided in the related art. The backlight unit 13 includes Mini LEDs 131 distributed in an array and dimmers 132 distributed in an array. Since the backlight unit 13 includes multiple dimmers 132, the configuration and wiring method of the dimmers 132 are important factors affecting the space efficiency of the backlight unit 13. Since the main direction of the data stream in the backlight unit 13 is often determined as one direction, and the input pin and the output pin of each dimmer 132 are determined, the dimmer 132 needs to be set according to the preset position, which makes the distance d1 of the Mini LEDs 131 in the leftmost column of the backlight unit 13 from the left side of the backlight unit 13 different from the distance d2 of the Mini LEDs 131 in the rightmost column of the backlight unit 13 from the right side of the backlight unit 13, that is, d1≠d2. Therefore, the light intensity on the left side of the backlight unit 13 is different from the light intensity on the right side thereof, which makes the edge of the image displayed on the liquid crystal panel 14 have a poor effect, affecting the user's perception.

FIG. 3 is another schematic structural diagram of a backlight unit provided in the related art. In the backlight unit 13, the distance d1 between the Mini LEDs 131 in the leftmost column of the backlight unit 13 and the left side of the backlight unit 13 is the same as the distance d2 between the Mini LEDs 131 in the rightmost column of the backlight unit 13 and the right side of the backlight unit 13, that is, d1=d2. As shown in FIG. 3, this arrangement requires that the dimmers in the leftmost column of the backlight unit 13 be rotated a certain angle for setting, which makes the routing of the dimmers very complicated, reducing the space efficiency of the backlight unit 13.

Based on this, the embodiments of the present application provide a method, device, dimmer and backlight unit for controlling a direction of data stream, so as to simplify the wiring of the dimmer in the backlight unit and improve the space efficiency of the backlight unit.

The solution provided in the embodiments of the present application is described in detail below with reference to the accompanying drawings.

### Embodiment 1

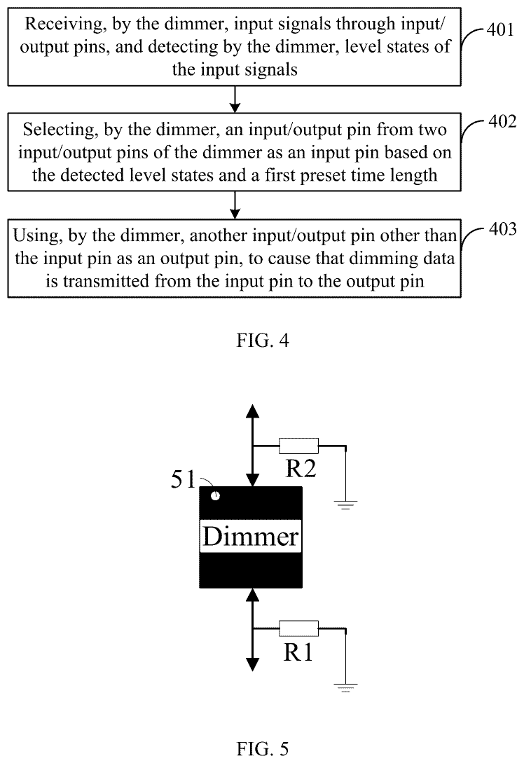

The embodiment of the present application provides a method for controlling the direction of data stream, performed by a backlight unit, and the backlight unit includes a dimmer. As shown in FIG. 4, the method includes the following steps.

At step 401, the dimmer receives input signals through input/output pins and detects level states of the input signals.

At step 402, the dimmer selects an input/output pin from two input/output pins of the dimmer as an input pin based on the detected level states and based on a first preset time length.

At step 403, the dimmer uses another input/output pin other than the input pin as an output pin, to cause that dimming data is transmitted from the input pin to the output pin.

It should be noted that, in the embodiment of the present application, each dimmer has two input/output pins, and each input/output pin is a bidirectional input/output pin.

In the embodiment of the present application, after the dimmer receives the input signals through the input/output pins, the level states of the input signals are detected, and based on the detected level state and the first preset time length, one input/output pin is selected from the two input/output pins of the dimmer and set as the input pin, and another input/output pin is set as the output pin, thereby determining the direction of data stream of the dimmer, that is, the data stream is input from the input pin and output from the output pin. After the direction of data stream of the dimmer is determined, the dimmer controller sends the dimming data to the dimmer so that the dimmer controls the brightness of the Mini LED according to the dimming data. Since the direction of data stream in the dimmer can be flexibly set, the wiring of the backlight unit can be simplified and the space efficiency of the backlight unit can be improved.

It should be noted that in the embodiments of the present application, the quantity of dimmers in the backlight unit is not limited. For example, if the backlight unit includes at least one group of cascaded dimmers, for each dimmer in each group of cascaded dimmers: if the dimmer is a first-level dimmer in the cascaded dimmers, the input signal is sent by the dimmer controller; if the dimmer is another level dimmer in the cascaded dimmers, the input signal is sent by the previous level dimmer of this dimmer, where the dimmer directly connected to the dimmer controller is the first-level dimmer.

Optionally, as shown in FIG. 5, which is a circuit structure diagram of a dimmer, an input/output pin of the dimmer distal to the positioning hole 51 is used as a first input/output pin, and an input/output pin of the dimmer close to the positioning hole 51 is used as a second input/output pin, where the first input/output pin of the dimmer is electrically connected to one terminal of the first resistor R1, the second input/output pin of the dimmer is electrically connected to one terminal of the second resistor R2, and another terminal of the first resistor R1 and another terminal of the second resistor R2 are both grounded. The first resistor R1 is used as a pull-down resistor of the first input/output pin, and the second resistor R2 is used as a pull-down resistor of the second input/output pin, so as to prevent the input/output pin of the dimmer from erroneous operation due to voltage floating at the initial power-on moment, thereby improving the stability and accuracy of the system.

In a specific implementation, each input/output pin of the dimmer may be connected to a pull-down resistor.

In the method for controlling the direction of data stream provided by the embodiment of the present application, the dimmer receives the input signals through the input/output pins and detects the level states of the input signals; the dimmer selects an input/output pin from the two input/output pins of the dimmer as an input pin based on the detected level states and based on the first preset time length; and the dimmer uses another input/output pin other than the input pin as the output pin to transmit the dimming data from the input pin to the output pin. The dimmer sets one input/output pin as the input pin and another input/output pin as the output pin according to the detected level states and the first preset time length, thereby determining the direction of data stream in the dimmer. Since the direction of data stream in the dimmer can be flexibly set, the dimmer can simplify the wiring when wiring in the backlight unit, while improving the space efficiency of the backlight unit.

In an optional implementation, the dimmer selects an input/output pin from two input/output pins of the dimmer as an input pin based on the detected level states and based on the first preset time length. The dimmer uses the input/output pin the detected level state of which is a preset level state and the preset level state of which lasts for the first preset time length as the input pin.

In a specific implementation, the dimmer detects that a level state of an input signal is a preset level state, and determines that the preset level state is maintained for the first preset time length, and uses the input/output pin that is input by the input signal as an input pin, and uses another input/output pin as an output pin, so that the dimming data is transmitted from the input pin to the output pin. Exemplarily, the first preset time length may be 4 μs, and the preset level state may be a constant level state, that is, if any input/output pin of the dimmer continuously receives an input signal of a constant level state within a time length of 4 μs, this input/output pin is set as an input pin that is input by the dimming data, and another input/output pin in the dimmer is set as an output pin for outputting dimming data to the next-level dimmer, or outputting a control signal to the Mini LED according to the dimming data to control the brightness of the Mini LED.

It should be noted that in the embodiment of the present application, the first preset time length can be 4 μs, 1 μs, or 5 μs. In addition to the us level, it can also be the ms level. In the specific implementation, it can be determined according to the actual situation, and the embodiment of the present application does not impose any restrictions on this. In addition, the constant level state in the embodiment of the present application can be a constant high level state or a constant low level state, and the embodiment of the present application does not impose any restrictions on this; and the Mini LED in the embodiment of the present application can be a direct-type AM Mini LED, and the embodiment of the present application does not impose any restrictions on this.

The following embodiments are described by taking the constant level state as a constant high level state as an example.

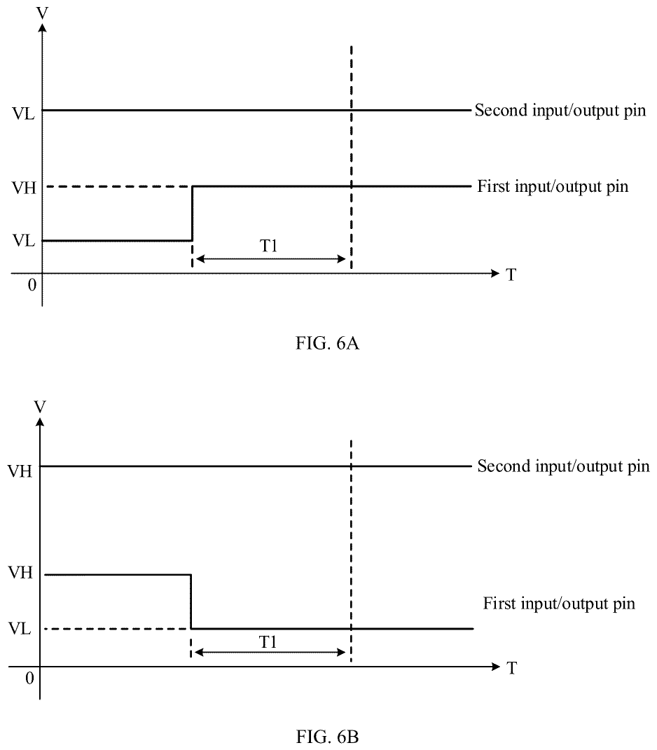

In a specific implementation, FIG. 6A is a waveform diagram of the input signals received by the input/output pins of the dimmer. In this figure, the horizontal axis is time (T) and the vertical axis is level (V). Combining FIG. 5 and FIG. 6A, it can be seen that since the input signal received by the first input/output pin of the dimmer is a constant high level state (VH) within the first preset time length T1, the dimmer sets its first input/output pin as an input pin and sets its second input/output pin as an output pin. Through the above method, the dimming data is input from the first input/output pin of the dimmer and output from the second input/output pin of the dimmer, thereby determining the direction of data stream of the dimmer.

Based on the same principle, if the input signal received by the second input/output pin of the dimmer is in a constant high level state (VH) within the first preset time length T1, the dimmer sets the second input/output pin as an input pin and sets the first input/output pin as an output pin, so that the dimming data is input from the second input/output pin of the dimmer and output from the first input/output pin of the dimmer, thereby determining the direction of data stream of the dimmer.

The following embodiments are described by taking the constant level state as a constant low level state as an example.

In a specific implementation, FIG. 6B is a waveform diagram of the input signals received by the input/output pins of the dimmer. In this figure, the horizontal axis is time (T) and the vertical axis is level (V). Combining FIG. 5 and FIG. 6B, it can be seen that since the input signal received by the first input/output pin of the dimmer is a constant low level state (VL) within the first preset time length T1, the dimmer sets its first input/output pin as an input pin and sets its second input/output pin as an output pin. Through the above method, the dimming data is input from the first input/output pin of the dimmer and output from the second input/output pin of the dimmer, thereby determining the direction of data stream of the dimmer.

Based on the same principle, if the input signal received by the second input/output pin of the dimmer is in a constant low level state (VL) within the first preset time length T1, the dimmer sets the second input/output pin as an input pin and sets the first input/output pin as an output pin, so that the dimming data is input from the second input/output pin of the dimmer and output from the first input/output pin of the dimmer, thereby determining the direction of data stream of the dimmer.

In the above method, the dimmer continuously detects the level state of the input signal, and if the level state is detected to be the preset level state within the first preset time length, the dimmer sets the input/output pin as the input pin for inputting dimming data. Since the dimmer needs to continuously detect the preset level state within the first preset time length, compared with the technical solution in the prior art of setting the input/output pin as the input pin after detecting the presence of a level jump in the input signal of the input/output pin, this method can reduce the probability of a level jump due to interference in the connection line, thereby reducing the probability of the input/output pin being set incorrectly, and improving the stability and accuracy of the system.

In an optional implementation, if the level states detected by the dimmer are the preset level state, and the input/output pins for which the preset level state lasts for the first preset time length includes two input/output pins, the dimmer determines the input/output pin that receives an input signal in the preset level state earlier from the two input/output pins, and uses the determined input/output pin as the input pin.

In the above method, if the level states detected by the dimmer are the preset level state, and the input/output pins for which the preset level state lasts for the first preset time length include two input/output pins, then the input/output pin that receives the input signal in the preset level state earlier from the two input/output pins is determined and used as the input pin, and another input/output pin other than the input pin is set as the output pin, thereby ensuring the accuracy and uniqueness of the direction of data stream in the dimmer.

In an optional implementation, if the backlight unit includes at least one group of cascaded dimmers, for each dimmer in each group of cascaded dimmers, the dimmer receives an input signal in the preset level state through an input pin within a second preset time length, and outputs a signal in a preset level state to the next-level dimmer connected to the dimmer through an output pin within a third preset time length; where the third preset time length is the product of the first preset time length and the quantity of subsequent-level dimmers of the dimmer, and the second preset time length is the sum of the third preset time length and the first preset time length.

It should be noted that, in the embodiment of the present application, if the backlight unit includes at least one group of cascaded dimmers, for each group of cascaded dimmers, one input/output pin of the first-level dimmer in this group of cascaded dimmers is electrically connected to the dimmer controller, and another input/output pin of the first-level dimmer therein is electrically connected to an input/output pin of the second-level dimmer; one input/output pin of the last-level dimmer in this group of cascaded dimmers is electrically connected to an input/output pin of the second-to-last-level dimmer, and another input/output pin of the last-level dimmer can be in a floating state, and the embodiment of the present application does not impose any restrictions on this.

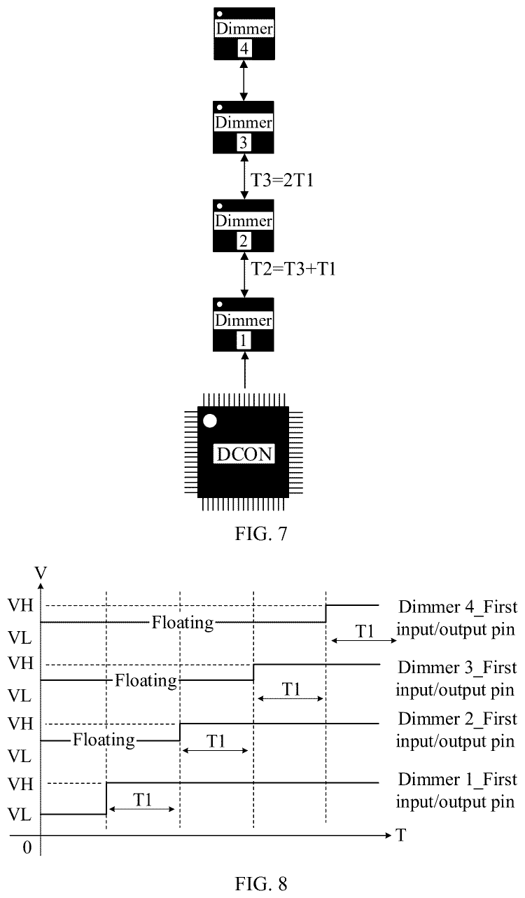

In a specific implementation, as shown in FIG. 7, it is assumed that there is a group of cascaded dimmers (Dimmer 1, Dimmer 2, Dimmer 3, Dimmer 4) in the backlight unit, and the group of dimmers is controlled by a dimmer controller (DCON) together. Since each dimmer needs to determine the direction of its data stream in turn, the input signal sent by the dimmer controller will first be transmitted to the input/output pins of Dimmer 1. For example, if Dimmer 1 detects that the input signal received by its first input/output pin is in a constant high-level state (VH) within the first preset time length T1, Dimmer 1 sets the first input/output pin as the input pin and sets the second input/output pin of Dimmer 1 as the output pin, thereby completing the setting of the direction of data stream of Dimmer 1. Then, Dimmer 1 continues to receive the input signal in the high-level state (VH) through the first input/output pin, and transmits the input signal in the high-level state to Dimmer 2 through the second input/output pin of Dimmer 1. Dimmer 2 then detects the received signal to determine the direction of its own data stream until it is transmitted to the last-level Dimmer. Then, the direction of data stream of each dimmer is set.

Therefore, in order to enable the cascaded dimmers (Dimmer 1, Dimmer 2, Dimmer 3, Dimmer 4) to complete the setting of their own direction of data stream, the time length of the input signal in the preset level state sent by the dimmer controller needs to be determined according to the quantity of cascaded dimmers and the first preset time length T1. The time length of the input signal in the preset level state sent by the dimmer controller is T2=T1×k, where T1 is the first preset time length and k is the quantity of cascaded dimmers. Exemplarily, if the quantity of cascaded dimmers is 4, the time length of the input signal in the preset level state sent by the dimmer controller is: 4×T1.

FIG. 7 is a circuit structure diagram of a connection of a DCON with dimmers provided in an embodiment of the present application. FIG. 8 is a waveform diagram of the input signals received by the input/output pins of four cascaded dimmers (Dimmer 1, Dimmer 2, Dimmer 3, Dimmer 4). In this figure, the horizontal axis is time (T) and the vertical axis is level (V). In combination with FIGS. 7 and 8, it can be seen that when a dimmer other than the first-level dimmer receives no input signal, the level state of its input/output pins is floating. Since the input signal needs to be transmitted step by step, the time length of the first-level dimmer (Dimmer 1) receiving the input signal in the preset level state through the input pin is 4×T1; the time length of the second-level dimmer (Dimmer 2) receiving the input signal in the preset level state through the input pin is 3×T1; the time length of the third-level dimmer (Dimmer 3) receiving the input signal in the preset level state through the input pin is 2×T1; and the time length of the fourth-level dimmer (Dimmer 4) receiving the input signal in the preset level state through the input pin is T1. Therefore, for the current dimmer, the second preset time length is the input time length of the current dimmer receiving the input signal in the preset level state, and the third preset time length is the output time length of the current dimmer outputting the input signal in the preset level state, which is also the input time length of the next-level dimmer connected to the current dimmer receiving the input signal in the preset level state.

Exemplarily, as shown in FIG. 7, if the second-level dimmer (Dimmer 2) is used as the current dimmer, the second-level dimmer receives an input signal in the preset level state through the input pin within the second preset time length, and outputs a signal in the preset level state to the third-level dimmer (Dimmer 3) through the output pin connected to the third-level dimmer (Dimmer 3) within the third preset time length. Since the second-level dimmer (Dimmer 2) is connected to the third-level dimmer (Dimmer 3) and the fourth-level dimmer (Dimmer 4) at its rear levels, the third preset time length is T3=T1×2=2T1; and the second preset time length is T2=T3+T1=T1×3=3T1.

In the above method, the backlight unit includes at least one group of cascaded dimmers. For each dimmer in each group of cascaded dimmers, the dimmer receives the input signal in the preset level state through the input pin within the second preset time length, and outputs the signal in the preset level state to the next-level dimmer connected to the dimmer through the output pin within the third preset time length. Through this method, the step-by-step determination of the direction of data stream in the dimmer is achieved, that is, after the direction of data stream of the first-level dimmer is determined, the direction of data stream of the second-level dimmer is determined, and so on, to ensure that the direction of data stream of each dimmer in the backlight unit is determined.

In an optional implementation, if a preset condition is met, the dimmer determines two input/output pins of the dimmer as input pins; where the preset condition is any one of the following conditions: condition 1: the dimmer is reset; condition 2: the backlight unit is powered on; or condition 3: the backlight unit is powered off.

In a specific implementation, once the direction of the data stream in the dimmer is determined, it cannot be changed to prevent the dimmer from being switched to an unexpected direction of data stream during the operation of the backlight unit, thereby damaging the dimming system or even burning the dimmer. However, if the backlight unit is powered on, or the backlight unit is powered off, or the dimmer is reset, the dimmer can be restored to its initial state, that is, two the input/output pins of the dimmer are input pins. In this way, the security of the system can be improved.

In the above method, if the backlight unit is powered on, or the backlight unit is powered off, or the dimmer is reset, the two input/output pins of the dimmer are restored to the initial state, that is, the two input/output pins are set to input pins. However, if none of the above situations occurs, the input/output pins of the dimmer remain unchanged to prevent the dimmer from being switched to an unexpected direction of data stream during the operation of the backlight unit, thereby damaging the dimming system or even burning the dimmer.

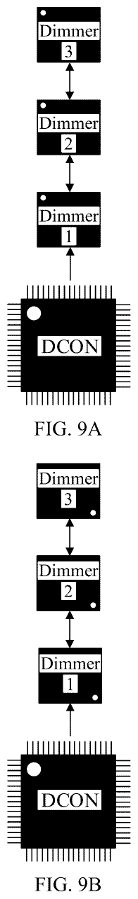

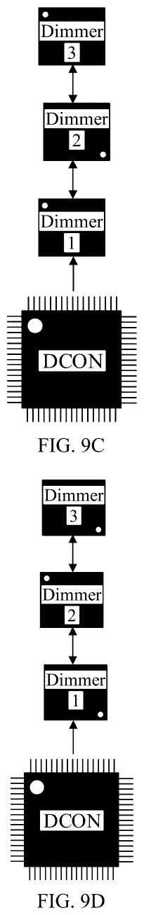

Through the above method, the direction of the data stream of the dimmer can be flexibly set. Therefore, as shown in FIGS. 9A, 9B, 9C and 9D, there are multiple connection methods between the dimmers and the DCON, and the wiring is simple without winding.

As shown in FIG. 9A, a group of cascaded dimmers (Dimmer 1, Dimmer 2, Dimmer 3) are all set in a forward direction.

As shown in FIG. 9B, a group of cascaded dimmers (Dimmer 1, Dimmer 2, Dimmer 3) are all set in a reverse direction.

As shown in FIG. 9C, in a group of cascaded dimmers (Dimmer 1, Dimmer 2, Dimmer 3), some dimmers (Dimmer 1, Dimmer 3) are set in the forward direction, and some dimmers (Dimmer 2) are set in the reverse direction.

As shown in FIG. 9D, in a group of cascaded dimmers (Dimmer 1, Dimmer 2, Dimmer 3), some dimmers (Dimmer 2) are set in the forward direction, and some dimmers (Dimmer 1, Dimmer 3) are set in the reverse direction.

### Embodiment 2

Based on the same concept, the embodiment of the present application also provides a dimmer included in a backlight unit. Since the device is the device in the method in the embodiment of the present application, and the principle of solving the problem by the device is similar to that of the method, the implementation of the device can refer to the implementation of the method, and the repeated parts will not be repeated.

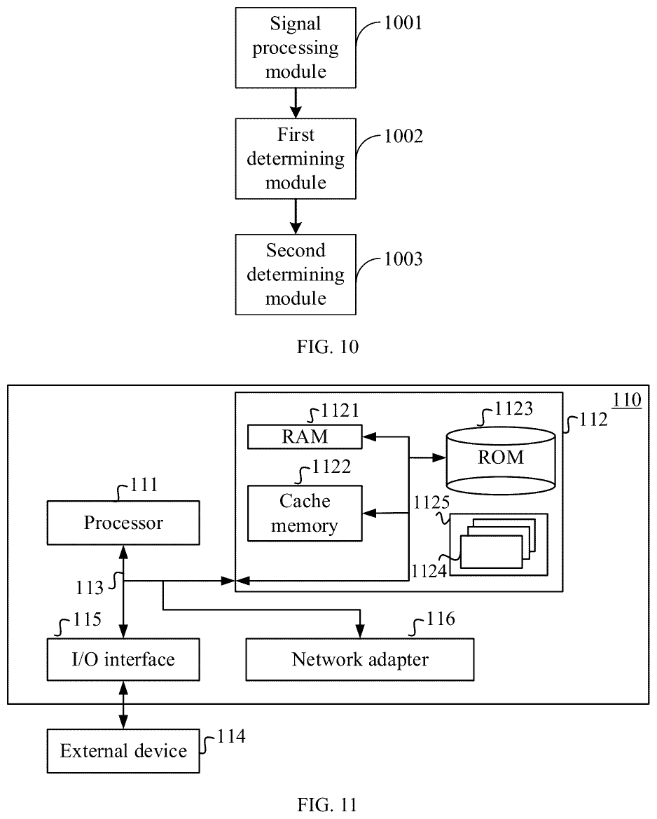

As shown in FIG. 10, the above device includes the following modules.

A signal processing module 1001 is configured for receiving input signals through input/output pins and detecting level states of the input signals.

A first determining module 1002 is configured for selecting an input/output pin from two input/output pins of the dimmer as an input pin based on the detected level states and based on a first preset time length.

A second determining module 1003 is configured for using another input/output pin other than the input pin as an output pin, to cause that dimming data is transmitted from the input pin to the output pin.

In an optional implementation, the first determining module 1002 is configured for: using the input/output pin the detected level state of which is a preset level state and the preset level state of which lasts for the first preset time length as the input pin.

In an optional implementation, the first determining module 1002 is further configured for: determining the input/output pin that receives an input signal in the preset level state earlier from the two input/output pins; and using the determined input/output pins as input pins.

In an optional implementation, if the backlight unit includes at least one group of cascaded dimmers, for each dimmer in each group of cascaded dimmers, the dimmer further includes an input-output module, configured for receiving an input signal in a preset level state through the input pin within a second preset time length, and outputting a signal in the preset level state to a next-level dimmer connected to the dimmer through the output pin within a third preset time length, where the third preset time length is a product of the first preset time length and a quantity of subsequent-level dimmers of the dimmer, and the second preset time length is a sum of the third preset time length and the first preset time length.

In an optional implementation, the dimmer further includes a reset module, configured for: setting the two input/output pins of the dimmer as input pins if a preset condition is met; where the preset condition is any one of following conditions: condition 1: the dimmer is reset; condition 2: The backlight unit is powered on; or condition 3: The backlight unit is powered off.

### Embodiment 3

Based on the same concept, the embodiment of the present application also provides a dimmer, which is included in the backlight unit. Since the dimmer is the dimmer in the method in the embodiment of the present application, and the principle of solving the problem by the dimmer is similar to that of the method, the implementation of the dimmer can refer to the implementation of the method, and the repeated parts will not be repeated.

The dimmer 110 according to this embodiment of the present application is described below with reference to FIG. 11. The dimmer 110 shown in FIG. 11 is only an example and should not bring any limitation to the function and scope of use of the embodiment of the present application.

As shown in FIG. 11, the dimmer 110 may be in the form of a general computing device, for example, it may be a terminal device. The components of the dimmer 110 may include, but are not limited to: the at least one processor 111, the at least one memory 112 storing executable instructions of the processor 111, and a bus 113 connecting different system components (including the memory 112 and the processor 111), and the processor 111 is a processor of a smart device.

The processor 111 executes the executable instructions to: receive input signals through input/output pins and detect level states of the input signals; select an input/output pin from two input/output pins of the dimmer as an input pin based on the detected level states and based on a first preset time length; and using another input/output pin other than the input pin as an output pin, to cause that dimming data is transmitted from the input pin to the output pin.

In an optional implementation, the processor 111 is further configured to: use the input/output pin the detected level state of which is a preset level state and the preset level state of which lasts for the first preset time length as the input pin.

In an optional implementation, the processor 111 is further configured to: determine the input/output pin that receives an input signal in the preset level state earlier from the two input/output pins; and use the determined input/output pins as the input pin.

In an optional implementation, if the backlight unit includes at least one group of cascaded dimmers, for each dimmer in each group of cascaded dimmers, the processor 111 is configured to: receive an input signal in a preset level state through the input pin within a second preset time length, and output a signal in the preset level state to a next-level dimmer connected to the dimmer through the output pin within a third preset time length; where the third preset time length is a product of the first preset time length and a quantity of subsequent-level dimmers of the dimmer, and the second preset time length is a sum of the third preset time length and the first preset time length.

In an optional implementation, the processor 111 is used to: if a preset condition is met, two input/output pins of the dimmer are set as input pins; where the preset condition is any one of following conditions: condition 1: the dimmer is reset; condition 2: the backlight unit is powered on; or condition 3: the backlight unit is powered off.

The bus 113 represents one or more of several types of bus structures, including a memory bus or memory controller, a peripheral bus, and a processor or local bus using any of a variety of bus architectures.

The memory 112 may include a readable medium in the form of a volatile memory, such as a random access memory (RAM) 1121 and/or a cache memory 1122, and may further include a read-only memory (ROM) 1123.

The memory 112 may also include a program/utility 1125 having a set (at least one) of program modules 1124, such program modules 1124 including but not limited to: an operating system, one or more application programs, other program modules, or program data, each of which or some combination may include an implementation of a network environment.

The dimmer 110 may also communicate with one or more external devices 114 (e.g., Mini LED, dimmer controller, etc.), one or more devices that enable a user to interact with the dimmer 110, and/or any device that enables the dimmer 110 to communicate with one or more other computing devices (e.g., routers, modems, etc.). Such communication may be performed through an input/output (I/O) interface 115. In addition, the dimmer 110 may also communicate with one or more networks (e.g., a local area network (LAN), a wide area network (WAN), and/or a public network, such as the Internet) through a network adapter 116. As shown, the network adapter 116 communicates with other modules of the dimmer 110 via the bus 113. It should be understood that, although not shown in the figures, other hardware and/or software modules may be used in conjunction with the dimmer 110, including but not limited to: microcode, device drivers, redundant processing units, external disk drive arrays, RAID systems, tape drivers, and data backup storage systems.

### Embodiment 4

Based on the same concept, an embodiment of the present application further provides a backlight unit, including a Mini LED(s) and a dimmer(s) as described in the above embodiment 3, where: the dimmer is configured for adjusting brightness of the Mini LED connected to the dimmer based on the dimming data.

The principle of solving the problem by the backlight unit is similar to that of the aforementioned dimmer, so the implementation of the backlight unit can refer to the implementation of the aforementioned dimmer, and the repeated parts will not be repeated.

### Embodiment 5

In some possible embodiments, various aspects of the present application may also be implemented in the form of a program product, which includes a program code. When the program product is run on a terminal device, the program code is used to enable the terminal device to execute the steps of each module in the device for controlling the direction of data stream according to various exemplary embodiments of the present disclosure described in the above “exemplary method” section of this specification. For example, the input signals are received through the input/output pins and the level states of the input signals are detected; an input/output pin is selected from two input/output pins of the dimmer as an input pin based on the detected level states and based on a first preset time length; and another input/output pin other than the input pin is used as an output pin to transmit dimming data from the input pin to the output pin.

The program product may employ any combination of one or more readable media. The readable medium may be a readable signal medium or a readable storage medium. The readable storage medium may be, e.g., but not limited to, an electrical, magnetic, optical, electromagnetic, infrared, or semiconductor system, apparatus or device, or any combination thereof. More specific examples of readable storage media (a non-exhaustive list) include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

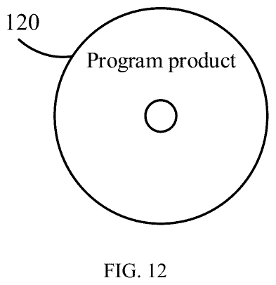

As shown in FIG. 12, a program product 120 for the method for controlling the direction of data stream according to an embodiment of the present application is described, which can be implemented in a portable compact disk read-only memory (CD-ROM) and includes program code, and can be run on a terminal device, such as a personal computer. However, the program product of the present application is not limited thereto, and herein, a readable storage medium can be any tangible medium containing or storing a program, which can be used by or in combination with an instruction execution system, apparatus, or device.

The readable signal medium may include data signals propagated in baseband or as part of a carrier wave, where readable program code is carried. Such propagated data signals may take a variety of forms, including, but not limited to, electromagnetic signals, optical signals, or any suitable combination of the foregoing. The readable signal medium may also be any readable medium other than a readable storage medium, which may transmit, propagate, or transfer a program for use by or in conjunction with an instruction execution system, apparatus, or device.

The program code embodied on the readable medium may be transmitted using any appropriate medium, including but not limited to wireless, wireline, optical fiber cable, RF, etc., or any suitable combination of the foregoing.

The program code for performing the operations of the present application may be written in any combination of one or more programming languages, including object-oriented programming languages such as Java, C++, etc., and conventional procedural programming languages such as “C” or similar programming languages. The program code may be executed, entirely on the user computing device, partially on the user device, as a separate software package, partially on the user computing device and partially on a remote computing device, or entirely on a remote computing device or server. In the case of a remote computing device, the remote computing device may be connected to the user computing device via any type of network, including a local area network (LAN) or a wide area network (WAN), or may be connected to an external computing device (e.g., via the Internet using an Internet service provider).

It should be noted that, although several modules or sub-modules of the system are mentioned in the above detailed description, this division is merely exemplary and not mandatory. In fact, according to the embodiments of the present application, the features and functions of two or more modules described above can be embodied in one module. Conversely, the features and functions of one module described above can be further divided into multiple modules to be embodied.

In addition, although the operations of the modules of the present application system are described in a specific order in the drawings, this does not require or imply that the operations must be performed in the specific order, or that all the operations shown must be performed to achieve the desired results. Additionally or alternatively, some operations may be omitted, multiple operations may be combined into one operation, and/or one operation may be decomposed into multiple operations.

The present application is described above with reference to the block diagrams and/or flow charts showing the methods, devices (systems) and/or computer program products according to the embodiments of the present application. It should be understood that a block of the block diagram and/or flow chart and a combination of blocks of the block diagram and/or flow chart can be implemented by computer program instructions. These computer program instructions can be provided to a processor of a general-purpose computer, a special-purpose computer and/or other programmable data processing device to produce a machine, so that the instructions executed by the computer processor and/or other programmable data processing device create a method for implementing the functions/actions specified in the block diagram and/or flow chart block.

Accordingly, the present application may also be implemented with hardware and/or software (including firmware, resident software, microcode, etc.) Further, the present application may take the form of a computer program product on a computer-usable or computer-readable storage medium, which has a computer-usable or computer-readable program code implemented in the medium, for use by or in conjunction with an instruction execution system. In the context of the present application, a computer-usable or computer-readable medium may be any medium that may contain, store, communicate, transmit, or convey a program for use by or in conjunction with an instruction execution system, device, or apparatus.

Obviously, those skilled in the art can make various changes and modifications to the present application without departing from the spirit and scope of the present application. Thus, if these modifications and variations of the present application fall within the scope of the claims of the present application and their equivalents, the present application is also intended to include these modifications and variations.

1. A method for controlling a direction of data stream, performed by a backlight unit, wherein the backlight unit comprises a dimmer, and the method comprises:
receiving, by the dimmer, input signals through input/output pins, and detecting by the dimmer, level states of the input signals;
selecting, by the dimmer, an input/output pin from two input/output pins of the dimmer as an input pin based on the detected level states and based on a first preset time length; and
using, by the dimmer, another input/output pin other than the input pin as an output pin, to cause that dimming data is transmitted from the input pin to the output pin.

2. The method according to claim 1, wherein the selecting, by the dimmer, an input/output pin from two input/output pins of the dimmer as an input pin based on the detected level states and based on a first preset time length, comprises:
using, by the dimmer, the input/output pin through which an input signal with the detected level state being a preset level state is provided and lasts for the first preset time length at the input/output pin as the input pin.

3. The method according to claim 2, wherein in response to that the level states detected by the dimmer are the preset level state, and the input/output pins through which the input signals with the preset level state are provided and lasts for the first preset time length at the input/output pins comprise the two input/output pins, the method further comprises:
determining, by the dimmer, an input/output pin that receives an input signal in the preset level state earlier from the two input/output pins; and
using, by the dimmer, the determined input/output pin as the input pin.

4. The method according to claim 1, wherein in response to that the backlight unit comprises at least one group of cascaded dimmers, for each dimmer in each group of cascaded dimmers, the method further comprises:
receiving, by the dimmer, an input signal in a preset level state through the input pin within a second preset time length, and outputting, by the dimmer, a signal in the preset level state to a next-level dimmer connected to the dimmer through the output pin within a third preset time length;
wherein the third preset time length is a product of the first preset time length and a quantity of subsequent-level dimmers of the dimmer, and the second preset time length is a sum of the third preset time length and the first preset time length.

5. The method according to claim 1, further comprising: in response to that a preset condition is met, setting, by the dimmer, the two input/output pins of the dimmer as input pins;
wherein the preset condition is any one of following conditions:
condition 1: the dimmer is reset;
condition 2: the backlight unit is powered on; or
condition 3: the backlight unit is powered off.

6-10. (canceled)

11. A dimmer, comprised in a backlight unit, wherein the dimmer comprises a memory and a processor, wherein the memory stores a computer program, and the processor, when executing the computer program, is configured for:
receiving input signals through input/output pins and detecting level states of the input signals;
selecting an input/output pin from two input/output pins of the dimmer as an input pin based on the detected level states and based on a first preset time length; and
configured for using another input/output pin other than the input pin as an output pin, to cause that dimming data is transmitted from the input pin to the output pin.

12. A backlight unit, comprising a mini light emitting diode (Mini LED) and the dimmer in claim 11, wherein:
the dimmer is configured for adjusting brightness of the Mini LED connected to the dimmer based on the dimming data.

13. The method according to claim 2, wherein the preset level state is a constant high level state or a constant low level state.

14. The method according to claim 1, further comprising:
receiving, by the dimmer, the dimming data as the input signals from a dimmer controller.

15. The method according to claim 1, wherein each input/output pin is a bidirectional input/output pin.

16. The method according to claim 1, wherein the dimmer is provided with a positioning hole,
an input/output pin of the dimmer distal to the positioning hole is electrically connected to one terminal of the first resistor, and another input/output pin of the dimmer close to the positioning hole is electrically connected to one terminal of the second resistor, and another terminal of the first resistor and another terminal of the second resistor are both grounded.

17. The method according to claim 4, wherein an output pin of a last-level dimmer of the at least one group of cascaded dimmers is floating.

18. The dimmer according to claim 11, wherein the processor is further configured for:
using, by the dimmer, the input/output pin through which an input signal with the detected level state being a preset level state is provided and lasts for the first preset time length at the input/output pin as the input pin.

19. The dimmer according to claim 18, wherein the processor is further configured for:
determining the input/output pin that receives an input signal in the preset level state earlier from the two input/output pins; and
using the determined input/output pin as the input pin.

20. The dimmer according to claim 11, wherein in response to that the backlight unit comprises at least one group of cascaded dimmers, for each dimmer in each group of cascaded dimmers, the processor is further configured for:
receiving an input signal in a preset level state through the input pin within a second preset time length, and outputting a signal in the preset level state to a next-level dimmer connected to the dimmer through the output pin within a third preset time length;
wherein the third preset time length is a product of the first preset time length and a quantity of subsequent-level dimmers of the dimmer, and the second preset time length is a sum of the third preset time length and the first preset time length.

21. The dimmer according to claim 11, wherein the processor is further configured for:
in response to that a preset condition is met, setting the two input/output pins of the dimmer as input pins;
wherein the preset condition is any one of following conditions:
condition 1: the dimmer is reset;
condition 2: the backlight unit is powered on; or
condition 3: the backlight unit is powered off.

22. The dimmer according to claim 18, wherein the preset level state is a constant high level state or a constant low level state.

23. The dimmer according to claim 11, wherein the processor is further configured for:
receiving, by the dimmer, the dimming data as the input signals from a dimmer controller.

24. The dimmer according to claim 11, wherein each input/output pin is a bidirectional input/output pin.

25. The dimmer according to claim 11, wherein the dimmer is provided with a positioning hole,
an input/output pin of the dimmer distal to the positioning hole is electrically connected to one terminal of the first resistor, and another input/output pin of the dimmer close to the positioning hole is electrically connected to one terminal of the second resistor, and another terminal of the first resistor and another terminal of the second resistor are both grounded.
